(19) United States
(12) Patent Application Publication
(10) Pub. No.: US 2022/0185939 A1
(43) Pub. Date: Jun. 16, 2022

(54) POLYOL COMPOSITION FOR PRODUCING FLEXIBLE POLYURETHANE FOAM, AND FLEXIBLE POLYURETHANE FOAM

(71) Applicant: SANYO CHEMICAL INDUSTRIES, LTD., Kyoto (JP)

(72) Inventors: Takuma TAHARA, Kyoto (JP); Tomohisa HIRANO, Kyoto (JP); Tomo SATO, Kyoto (JP)

(73) Assignee: SANYO CHEMICAL INDUSTRIES, LTD., Kyoto (JP)

(21) Appl. No.: 17/432,256

(22) PCT Filed: Feb. 20, 2020
(86) PCT No.: PCT/JP2020/006856

§ 371 Date: Aug. 19, 2021

(30) Foreign Application Priority Data
Feb. 25, 2019 (JP) 2019-031866

(51) Int. Cl. C08G 18/08; C08G 18/12; C08G 18/42; C08G 18/48; C08G 18/76

(52) U.S. Cl. CPC C08G 18/14; C08G 18/12; C08G 18/4211; C08G 2101/00; C08G 18/4837; C08G 18/7621; C08G 18/4244

(57) ABSTRACT

The present invention aims to provide a polyol composition capable of producing a flexible polyurethane foam having excellent low resilience at room temperature and good breathability. The present invention provides a polyol composition (C) for producing flexible polyurethane foam, containing a polyester polyol (A) and a polyether polyol (B), wherein the followings (1) to (4) are satisfied: (1) the polyol composition (C) has an ester group concentration of 0.4 to 4.0 mmol/g based on the weight of the polyol composition (C); (2) the polyol composition (C) has an oxyethylene group unit content of 15 to 40 wt % based on the weight of the polyol composition (C); (3) the polyester polyol (A) includes a polyester polyol (A1) having two to four hydroxy groups in one molecule obtained by polymerization of a raw material containing a compound (a) having multiple hydroxyl groups and a polycarboxylic acid or acid anhydride of the polycarboxylic acid; and (4) the polyether polyol (B) includes an oxyethylene group-containing polyether polyol (B1).

### TECHNICAL FIELD

The present invention relates to a polyol composition for producing flexible polyurethane foam and a flexible polyurethane foam made from the polyol composition. Specifically, the present invention relates to a flexible polyurethane foam having excellent low resilience and excellent breathability, and a polyol composition for producing flexible polyurethane foam, which is suitable for such a flexible polyurethane foam.

### BACKGROUND ART

Flexible polyurethane foam is widely used for furniture, bedding mattresses, car seat cushions, clothing, and the like. Flexible polyurethane foam having high breathability and low resilience is preferred particularly for bedding pillows and mattresses.

Known flexible polyurethane foam includes one that is made from a polyol composition containing a polyester triol by reaction in the presence of an organic polyisocyanate, a foaming agent, a catalyst, and a foam stabilizer (for example, Patent Literature 1).

Yet, while the polyol composition for polyurethane foam disclosed in Patent Literature 1 has excellent low resilience at room temperature, its breathability is insufficient.

### CITATION LIST

Patent Literature
Patent Literature 1: JP 2014-185335 A

### SUMMARY OF INVENTION

### Technical Problem

The present invention aims to provide a polyol composition that makes it possible to produce a flexible polyurethane foam having excellent low resilience at room temperature and good breathability.

### Solution to Problem

As a result of extensive studies to achieve the aim, the present inventors arrived at the present invention.

Specifically, the present invention provides a polyol composition (C) for producing flexible polyurethane foam, containing a polyester polyol (A) and a polyether polyol (B), wherein (1) to (4) described below are satisfied; and a flexible polyurethane foam which is a reaction product of a mixture containing the polyol composition (C) for producing flexible polyurethane foam, an organic polyisocyanate (D), a foaming agent (E), a catalyst (F), and a foam stabilizer (G).

(1) The polyol composition (C) has an ester group concentration of 0.4 to 4.0 mmol/g based on the weight of the polyol composition (C).

(2) The polyol composition (C) has an oxyethylene group unit content of 15 to 40 wt % based on the weight of the polyol composition (C).

(3) The polyester polyol (A) includes a polyester polyol (A1) having two to four hydroxy groups in one molecule obtained by polymerization of a raw material containing a compound (a) having multiple hydroxyl groups and a polycarboxylic acid or acid anhydride of the polycarboxylic acid.

(4) The polyether polyol (B) includes an oxyethylene group-containing polyether polyol (B1).

### Advantageous Effects of Invention

A flexible polyurethane foam having both excellent low resilience and excellent breathability can be produced by using the polyol composition for producing flexible polyurethane foam of the present invention.

### DESCRIPTION OF EMBODIMENTS

A polyol composition (C) for producing flexible polyurethane foam of the present invention contains a polyester polyol (A) and a polyether polyol (B), wherein the followings (1) to (4) are satisfied:

(1) the polyol composition (C) has an ester group concentration of 0.4 to 4.0 mmol/g based on the weight of the polyol composition (C);

(2) the polyol composition (C) has an oxyethylene group unit content of 15 to 40 wt % based on the weight of the polyol composition (C);

(3) the polyester polyol (A) includes a polyester polyol (A1) having two to four hydroxy groups in one molecule obtained by polymerization of a raw material containing a compound (a) having multiple hydroxyl groups and a polycarboxylic acid or acid anhydride of the polycarboxylic acid; and

(4) the polyether polyol (B) includes an oxyethylene group-containing polyether polyol (B1).

Examples of the polyester polyol (A) include the polyester polyol (A1) having two to four hydroxy groups in one molecule obtained by polymerization of a raw material containing the compound (a) having multiple hydroxyl groups and a polycarboxylic acid or acid anhydride of the polycarboxylic acid, and a polyester polyol (A2) different from the polyester polyol (A1). The polyester polyol (A1) is an essential component.

The polyester polyol (A1) having two to four hydroxy groups in one molecule obtained by polymerization of a raw material containing the compound (a) having multiple hydroxyl groups and a polycarboxylic acid or acid anhydride of the polycarboxylic acid is a polymerization reaction product of a raw material containing the compound (a) having multiple hydroxyl groups and a polycarboxylic acid or acid anhydride of the polycarboxylic acid, and it is a polyester polyol having two to four hydroxy groups in one molecule. When the polyester polyol (A1) has less than two hydroxy groups in one molecule, disintegration of the foam occurs during foaming, and when the polyester polyol (A1) has more than four hydroxy groups in one molecule, shrinkage of the foam occurs. Thus, it is not possible to produce good quality flexible polyurethane foam in either case.

Examples of the polyester polyol (A1) include a condensation reaction product of the compound (a) having multiple hydroxyl groups with a polycarboxylic acid or acid anhydride of the polycarboxylic acid (including a transesterification reaction product of the compound (a) having multiple hydroxyl groups with a lower alkyl ester of a polycarboxylic acid) (A11); an ester group-containing reaction product (A12) obtained by adding a carboxylic acid or acid anhydride of the polycarboxylic acid to a polyether polyol obtained by adding an alkylene oxide (hereinafter abbreviated to “AO”) to the compound (a) having multiple hydroxyl groups; and a reaction product (A13) obtained by further adding AO to (A11) or (A12).

These polyester polyols (A1) may be used alone or in combination of two or more.

Examples of the compound (a) having multiple hydroxyl groups include a polyhydric alcohol (a1) and a compound (a2) having multiple hydroxyl groups different from the polyhydric alcohol (a1).

Examples of the polyhydric alcohol (a1) include C2-C20 dihydric alcohols, C3-C20 trihydric alcohols, and C4-C20 tetrahydric to octahydric alcohols.

Examples of the C2-C20 dihydric alcohols include aliphatic diols (e.g., ethylene glycol, propylene glycol, 1,3- or 1,4-butanediol, 1,6-hexanediol, and neopentyl glycol), and alicyclic diols (e.g., cyclohexane diol and cyclohexanedimethanol).

Examples of the C3-C20 trihydric alcohols include aliphatic triols (e.g., glycerol and trimethylolpropane).

Examples of the C4-C20 tetra- to octahydric alcohol include aliphatic polyols (e.g., pentaerythritol, sorbitol, mannitol, sorbitan, diglycerol, and dipentaerythritol) and sugars (e.g., sucrose, glucose, mannose, fructose, methylglucoside, and derivatives thereof).

Examples of the compound (a2) having multiple hydroxyl groups different from the polyhydric alcohol (a1) include polyphenols (hydroquinone, bisphenol A, bisphenol F, bisphenol S, 1,3,6,8-tetrahydroxynaphthalene, anthrol, 1,4,5,8-tetrahydroxyanthracene, and 1-hydroxypyrene), polybutadiene polyols, castor oil-based polyols, polymers of hydroxy group-containing monomers (e.g., (co)polymers of hydroxyalkyl (meth)acrylate having a hydroxyl group number of 2 to 100, and polyvinyl alcohols), condensates of phenols and formaldehydes (e.g., novolak); and polyphenols described in U.S. Pat. No. 3,265,641.

The “(meth)acrylate” means methacrylate and/or acrylate. The same shall apply hereinafter.

The compound (a) having multiple hydroxyl groups is preferably the polyhydric alcohol (a1), more preferably propylene glycol or glycerol, particularly preferably glycerol.

Examples of the polycarboxylic acid or acid anhydride of the polycarboxylic acid include aliphatic polycarboxylic acids, aromatic polycarboxylic acids, and cyclic acid anhydrides produced by dehydration condensation in the molecules of these acids.

Examples of the aliphatic polycarboxylic acids include succinic acid, fumaric acid, sebacic acid, and adipic acid.

Examples of the aromatic polycarboxylic acids include C8-C18 aromatic polycarboxylic acids such as phthalic acid, isophthalic acid, terephthalic acid, 2,2′-bibenzyldicarboxylic acid, trimellitic acid, hemimellitic acid, trimesic acid, pyromellitic acid, naphthalene-1,4-dicarboxylic acid, naphthalene-2,3,6-tricarboxylic acid, diphenic acid, 2,3-anthracenedicarboxylic acid, 2,3,6-anthracenetricarboxylic acid, and pyrenedicarboxylic acid.

In view of hydrolysis resistance, the polycarboxylic acid or acid anhydride of the polycarboxylic acid is preferably an aromatic dicarboxylic acid or acid anhydride of the polycarboxylic acid, more preferably phthalic anhydride.

Examples of the lower alkyl ester of the polycarboxylic acid include esters of aliphatic polycarboxylic acids or aromatic polycarboxylic acids with C1-C4 aliphatic alcohols.

Examples of the C1-C4 aliphatic alcohols to produce the lower alkyl ester of the polycarboxylic acid include methanol, ethanol, propanol, and butanol. Specific examples of the lower alkyl ester of the polycarboxylic acid include dimethyl phthalate and dimethyl terephthalate.

Examples of AO used to produce the polyester polyol (A1) include C2-C4 AOs, such as ethylene oxide (hereinafter abbreviated to “EO”), 1,2-propylene oxide (hereinafter abbreviated to “PO”), 1,3-propylene oxide, 1,2-butylene oxide, and 1,4-butylene oxide. In view of reactivity, EO and PO are preferred, and PO is more preferred. When two or more AOs are used in combination, these AOs may be added by block addition, random addition, or a combination thereof.

In view of viscosity of the polyester polyol (A1), the number of moles of AO added is preferably 3 to 16 moles per hydroxy group in the compound (a) having multiple hydroxyl groups.

In view of foam hardness, the polyester polyol (A1) is preferably a reaction product obtained by adding an aromatic dicarboxylic acid anhydride and PO to a trifunctional polyether polyol.

Examples of the polyester polyol (A2) different from the polyester polyol (A1) include a polylactone polyol (A21) (e.g., one obtained by ring opening polymerization of a lactone (e.g., ε-caprolactone) using the polyhydric alcohol (a1) as an initiator), a polycarbonate polyol (A22) (e.g., a reaction product of the polyhydric alcohol (a1) with an alkylene carbonate), and a reaction product obtained by further adding AO to (A21) or (A22).

These polyester polyols (A2) may be used alone or in combination of two or more.

Examples of AO used for the polyester polyol (A2) different from the polyester polyol (A1) include the same as those used for (A1).

In view of handling of the polyester polyol (A), the hydroxy value of the polyester polyol (A) is preferably 25 to 150 mg KOH/g, more preferably 40 to 100 mg KOH/g.

The term “hydroxy value” as used herein refers to the number of milligrams of potassium hydroxide required to neutralize the acetic acid bonded to hydroxy groups in the acetylation of 1 g of sample, and is measured by the method described in “JIS K 1557-1 Plastics—Polyols for use in the production of polyurethane—Part 1: Determination of hydroxyl number”.

In view of handling of the polyester polyol (A), the ester group concentration in the polyester polyol (A) is preferably 0.5 to 10.0 mmol/g, more preferably 0.5 to 7.0 mmol/g, based on the weight of the polyester polyol (A).

The ester group concentration in the polyester polyol (A) can be calculated using the intensity of peaks derived from ester groups determined by infrared (IR) spectroscopic analysis of the polyester polyol (A) and a calibration curve of peak intensity and ester group concentration prepared using a sample whose ester group concentration is known.

The polyester polyol (A1) content in the polyol composition (C) is preferably 7 to 65 wt % based on the total weight of the polyol composition (C).

Examples of the polyether polyol (B) include an oxyethylene group-containing polyether polyol (B1) and a polyether polyol (B2) different from the (B1). The polyether polyol (B1) is an essential component. In the present invention, the polyether polyol (B) does not include a compound having an ester group.

The polyether polyol (B) of the present invention may be an adduct of AO to an active hydrogen group-containing compound (b). A reaction product that at least contains ethylene oxide as AO is the polyether polyol (B1); and a reaction product that does not contain ethylene oxide is the polyether polyol (B2).

Examples of the active hydrogen group-containing compound (b) include a polyhydric alcohol (b1), a compound (b2) having multiple hydroxyl groups different from the polyhydric alcohol (b1), an amino group-containing compound (b3), a thiol group-containing compound (b4), and a phosphoric acid group-containing compound (b5).

The “active hydrogen” means a hydrogen atom bonded to an oxygen atom, a nitrogen atom, a sulfur atom, or the like. The “active hydrogen group-containing compound” means a compound having an active hydrogen-containing functional group (e.g., a hydroxy group, an amino group, a thiol group, or a phosphoric acid group) in the molecule.

These polyether polyols (B) may be used alone or in combination of two or more.

Examples of the polyhydric alcohol (b1) include the same as those of the polyhydric alcohol (a1).

Examples of the compound (b2) having multiple hydroxyl groups different from the polyhydric alcohol (b1) include the same as those of the compound (a2) having multiple hydroxyl groups different from the polyhydric alcohol (a1).

Examples of the amino group-containing compound (b3) include ammonia, amines, polyamines, and amino alcohols. Specific examples include ammonia, C1-C20 alkylamines (e.g., butylamine), aniline, aliphatic polyamines (e.g., ethylenediamine, hexamethylenediamine, and diethylenetriamine), heterocyclic polyamines (e.g., piperazine and N-aminoethylpiperazine), alicyclic polyamines (e.g., dicyclohexylmethanediamine and isophoronediamine), aromatic polyamines (e.g., phenylenediamine, tolylenediamine, and diphenylmethanediamine), alkanolamines (e.g., monoethanolamine, diethanolamine, and triethanolamine), polyamide polyamines obtainable by condensation of a dicarboxylic acid with excess polyamine, polyether polyamines, hydrazines (e.g., hydrazine and monoalkylhydrazine), dihydrazides (e.g., succinic acid dihydrazide and terephthalic acid dihydrazide), guanidines (e.g., butylguanidine and 1-cyanoguanidine), and dicyandiamide.

Examples of the thiol group-containing compound (b4) include polythiol compounds. Examples of the polythiol include divalent to octavalent thiols. Specific examples include ethanedithiol and 1,6-hexanedithiol.

Examples of the phosphoric acid group-containing compound (b5) include phosphoric acid, phosphorus acid, and phosphoric acid.

Examples of AO to be addition-polymerized to the active hydrogen group-containing compound (b) include C2-C4 AOs, such as EO, PO, 1,3-propylene oxide, 1,2-butylene oxide, and 1,4-butylene oxide.

When two or more AOs are used in combination, these AOs may be added by block addition, random addition, or a combination thereof.

In the case of the polyether polyol (B1) that is an essential component, it is essential that EO is contained, and preferably EO and PO are contained, in view of breathability of the foam.

In the case of the polyether polyol (B2), preferably, PO is contained.

In view of viscosity of the polyether polyol (B1), the number of moles of AO added to the polyether polyol (B1) is preferably 15 to 70 moles per hydroxy group in the compound (b) having multiple hydroxyl groups. The number of moles of EO added to the polyether polyol (B1) is preferably 10 to 65 moles.

In view of viscosity of the polyether polyol (B2), the number of moles of AO added to the polyether polyol (B2) is preferably 3 to 90 moles per hydroxy group in the compound (b) having multiple hydroxyl groups.

In view of resilience, the polyether polyol (B) preferably has a hydroxy value of 20 to 500 mg KOH/g, more preferably 30 to 300 mg KOH/g.

Preferably, in view of foam hardness, the polyether polyol (B) includes a bifunctional polyether polyol or a trifunctional polyether polyol. More preferably, in view of foam hardness and restoration time of the foam, the polyether polyol (B) includes a bifunctional polyether polyol and a trifunctional polyether polyol.

The polyether polyol (B1) content in the polyol composition (C) is preferably 20 to 55 wt % based on the total weight of the polyol composition (C).

The polyol composition (C) for producing flexible polyurethane foam of the present invention may contain another polyol different from the polyester polyol (A) and the polyether polyol (B).

Examples of the other polyol include a polymer polyol (P).

The other polyol may be of one type or a combination of two or more types.

The polymer polyol (P) used in the present invention is a polymer polyol containing polymer particles (J) in which an ethylenically unsaturated compound is a constituent monomer. In view of viscosity of the polymer polyol (P), the volume average particle size of the polymer particles (J) is preferably 0.1 to 1.5 μm, more preferably 0.3 to 1.1 μm, particularly preferably 0.4 to 0.9 μm.

Examples of the ethylenically unsaturated compound to form the polymer particles (J) include acrylonitrile, styrene, and another ethylenically unsaturated compound. In view of foam hardness, preferred of these as essential components are styrene and acrylonitrile. In view of hardness and dispersibility of the polymer particles (J), the ethylenically unsaturated compound is preferably one in which the total content of styrene and acrylonitrile is 80 to 100 wt % based on the weight of the ethylenically unsaturated compound forming the polymer particles (J).

The polymer particle (J) content is preferably 0 to 10 wt % based on the weight of the whole polyol composition (C).

The polymer polyol (P) is obtained by polymerizing the ethylenically unsaturated compound in a polyol in the presence of a radical polymerization initiator. Examples of the polyol in the polymer polyol (P) include the polyester polyol (A) and the polyether polyol (B). In view of homogeneity and dispersibility of the polymer particles (J) in the polyol, it is preferred to polymerize the ethylenically unsaturated compound in the polyether polyol (B).

When the polyol in the polymer polyol (P) is the polyester polyol (A), the weight of the polyol in the polymer polyol (P) is treated as the weight of the polyester polyol (A) in the polyol composition (C).

When the polyol in the polymer polyol (P) is the polyether polyol (B), the weight of the polyol in the polymer polyol (P) is treated as the weight of the polyether polyol (B) in the polyol composition (C).

These polymer polyols (P) may be used alone or in combination of two or more.

The polyol composition (C) in the present invention is easily obtained by mixing the polyester polyol (A), polyether polyol (B), and other polyol(s).

A known mixer (e.g., a container equipped with a stirrer) can be used when mixing by a mixing method.

When the polyol composition (C) contains polymer particles, preferably, the polymer particles are the polymer particles (J) in the polymer polyol (P), and the polymer particles (J) serving as the polymer polyol (P) are mixed with another raw material to produce the polyol composition (C) for producing flexible polyurethane foam.

In view of storage stability and the like, preferably, the oxygen concentration in the container is reduced when mixing.

The ester group concentration in the polyol composition (C) in the present invention is 0.4 to 4.0 mmol/g based on the weight of the polyol composition (C). In view of handling of the polyol composition (C), the ester group concentration is preferably 0.4 to 2.0 mmol/g. When the ester group concentration is less than 0.4 mmol/g, the polyurethane foam has high resilience. When the ester group concentration is more than 4.0 mmol/g, the polyurethane foam has poor breathability.

The ester group concentration in the polyol composition (C) can be calculated using the intensity of peaks derived from ester groups determined by infrared (IR) spectroscopic analysis of the polyol composition (C) and a calibration curve of peak intensity and ester group concentration prepared using a sample whose ester group concentration is known.

In view of breathability and reactivity, the oxyethylene group unit content in the polyol composition (C) is 15 to 40 wt %, preferably 15 to 30 wt %, based on the total weight of the polyol composition (C). When the oxyethylene group unit content is less than 15 wt %, the polyurethane foam has poor breathability. When the oxyethylene group unit content is more than 40 wt %, the polyurethane foam has poor formability.

Examples of the polyol having an oxyethylene group unit in the polyol composition (C) also include the polyester polyol (A) and other polyols each having an oxyethylene group unit, in addition to the polyether polyol (B).

To determine the oxyethylene group unit content in the polyol composition (C), the polyol components in the polyol composition (C) are fractionated by gel permeation chromatography (GPC); each polyol is measured by proton nuclear magnetic resonance analysis (¹H-NMR) to calculate the oxyethylene group unit content in each polyol from a formula described below; the oxyethylene group unit content in each polyol is multiplied by the content ratio by weight of the corresponding polyol in the polyol composition (C); and the resulting values are added, whereby the oxyethylene group unit content can be calculated as the sum (arithmetic mean).

Oxyethylene group unit content (wt %) in each polyol=44α×100/(44α+58),

where

### α={(B/A−1)×3−58β}/(4+44β);

### β=H/(M−S);

A: Integration ratio of peaks at 0.0 to 2.0 ppm (—CH₃);
B: Integration ratio of peaks at 2.5 to 6.4 ppm (—CH₂—, —CH—);
M: Molecular weight of each polyol;
H: Number of hydrogen atoms in starting material of each polyol; and
S: Molecular weight of starting material of each polyol.

Here, the term “starting material of each polyol” refers to a compound that forms each polyol, excluding AO. For example, the starting materials of the polyester polyol (A) are the compound (a) having multiple hydroxyl groups and a polycarboxylic acid or acid anhydride of the polycarboxylic acid. The starting material of the polyether polyol (B) is the active hydrogen group-containing compound (b).

The hydroxy value of the polyol composition (C) is preferably 80 to 200 mg KOH/g, more preferably 95 to 138 mg KOH/g. When the hydroxy value is in these ranges, the polyurethane foam has low resilience at 25° C., and the foam does not become hard even at 0° C., resulting in low temperature dependence of the foam hardness.

The hydroxy value of the polyol composition (C) is the sum (arithmetic mean) of values each obtained by multiplying the hydroxy value of each of the polyester polyol (A), polyether polyol (B), polymer polyol (P), and other hydroxy group-containing compound(s) by the content ratio by weight of the corresponding component. The weight of the polymer polyol (P) includes the weight of the polymer particles (J).

Specifically, the measurement is performed according to “JIS K 1557-1 Plastics—Polyols for use in the production of polyurethane—Part 1: Determination of hydroxyl number” described above.

In view of breathability and durability of the polyurethane foam, the number average number of functional groups of the polyols in the polyol composition (C) is preferably 2.6 to 4.0, more preferably 2.7 to 3.8.

The number average number of functional groups is the sum (arithmetic mean) of values each obtained by multiplying the number of functional groups of each of the polyester polyol (A), polyether polyol (B), polymer polyol (P), and other hydroxy group-containing compound(s) in the polyol composition (C) by the content ratio by mole of the corresponding component.

The number average number of functional groups in the polyol composition (C) can also be calculated by fractionating each polyol component in the polyol composition (C) by GPC and measuring each polyol by nuclear magnetic resonance (¹³C-NMR) analysis.

A flexible polyurethane foam which is a reaction product of a mixture containing the polyol composition (C) for producing flexible polyurethane foam, an organic polyisocyanate (D), a foaming agent (E), a catalyst (F), and a foam stabilizer (G) is also encompassed by the present invention.

The organic polyisocyanate (D) may be any known organic polyisocyanate used in flexible polyurethane foam. Examples include an aromatic polyisocyanate (D1), an aliphatic polyisocyanate (D2), an alicyclic polyisocyanate (D3), an aromatic-aliphatic polyisocyanate (D4), a modified polyisocyanate (D5) of any of these (e.g., a modified product containing a urethane group, carbodiimide group, allophanate group, urea group, burette group, isocyanurate group, or oxazolidone group), and mixtures of two or more of these.

Examples of the aromatic polyisocyanate (D1) (in the following polyisocyanates shown with the carbon number, carbon atoms in the isocyanate group are excluded) include C6-C16 (excluding carbon atoms in the isocyanate group) aromatic diisocyanates, C6-C20 aromatic triisocyanates, and crude products of these isocyanates. Specific examples include 1,3- or 1,4-phenylene diisocyanate, 2,4- or 2,6-tolylene diisocyanate (hereinafter abbreviated to “TDI”), crude TDI, 2,4′- or 4,4′-diphenylmethane diisocyanate (hereinafter abbreviated to “MDI”), polymethylene polyphenylene polyisocyanate (hereinafter abbreviated to “crude MDI”), naphthylene-1,5-diisocyanate, and triphenylmethane-4,4′,4″-triisocyanate.

Examples of the aliphatic polyisocyanate (D2) include C6-C10 aliphatic diisocyanates. Specific examples include 1,6-hexamethylene diisocyanate, 2,2,4-trimethylhexamethylene diisocyanate, and lysine diisocyanate.

Examples of the alicyclic polyisocyanate (D3) include C6-C16 alicyclic diisocyanates. Specific examples include isophorone diisocyanate, 4,4′-dicyclohexylmethane diisocyanate, 1,4-cyclohexane diisocyanate, and norbornane diisocyanate.

Examples of the aromatic aliphatic isocyanate (D4) include C8-C12 aromatic aliphatic diisocyanates. Specific examples include xylylene diisocyanate and α,α,α′,α′-tetramethylxylylene diisocyanate.

Examples of the modified polyisocyanate (D5) include urethane group-modified polyisocyanates, carbodiimide group-modified polyisocyanates, allophanate group-modified polyisocyanates, urea group-modified polyisocyanates, burette group-modified polyisocyanates, isocyanurate group-modified polyisocyanates, and oxazolidone group-modified polyisocyanates. Specific examples include carbodiimide-modified MDI.

In view of reactivity and resilience, the organic polyisocyanate (D) is preferably the aromatic polyisocyanate (D1), more preferably TDI, crude TDI, MDI, crude MDI, or a modified product of any of these isocyanates, particularly preferably TDI, MDI, or crude MDI.

Polyurethane foam is obtained by reacting the polyol composition (C) with the organic polyisocyanate (D). The amount of the organic polyisocyanate (D) is adjusted to adjust the proportion of isocyanate groups (hereinafter abbreviated to “NCO groups”) to active hydrogen atoms in the raw material, whereby the physical properties of the polyurethane foam can be adjusted.

In view of resilience, the isocyanate index (index) (equivalent ratio of (NCO group/active hydrogen atom-containing group)×100) in flexible polyurethane foam production is preferably 70 to 150, more preferably 75 to 130, particularly preferably 80 to 120.

Examples of the foaming agent (E) include water, liquefied carbon dioxide, and low-boiling compounds having a boiling point of −5° C. to 70° C.

Examples of the low-boiling compounds include hydrogen atom-containing halogenated hydrocarbons and low-boiling hydrocarbons. Specific examples of the hydrogen atom-containing halogenated hydrocarbons and low-boiling hydrocarbons include methylene chloride, hydrochlorofluorocarbons (HCFCs)) (e.g., HCFC-123, HCFC-141b, and HCFC-142b), hydrofluorocarbons (HFCs) (e.g., HFC-134a, HFC-152a, HFC-356mff, HFC-236ea, HFC-245ca, HFC-245fa, and HFC-365mfc), butane, pentane, and cyclopentane.

In view of formability, the foaming agent (E) is preferably water, liquefied carbon dioxide, methylene chloride, cyclopentane, HCFC-141b, HFC-134a, HFC-356mff, HFC-236ea, HFC-245ca, HFC-245fa, HFC-365mfc, or a mixture of two or more of these.

In view of foam density, the amount of water as the foaming agent (E) is preferably 1.0 to 8.0 parts by weight, more preferably 1.5 to 4.0 parts by weight, relative to 100 parts by weight of the polyol composition (C) used in urethane foam production.

In view of formability, the amount of the low-boiling compound is preferably 30 parts by weight or less, more preferably 5 to 25 parts by weight, relative to 100 parts by weight of the polyol composition (C).

The amount of the liquefied carbon dioxide is preferably 30 parts by weight or less, more preferably 1 to 25 parts by weight, relative to 100 parts by weight of the polyol composition (C).

The catalyst (F) can be any catalyst that promotes urethane-forming reaction. In view of formability, examples include tertiary amines (e.g., triethylenediamine, N-ethylmorpholine, N,N-dimethylaminoethanol, bisdimethylaminoethyl ether, and N—(N′,N′-2-dimethylaminoethyl)morpholine) and carboxylic acid metal salts (e.g., potassium acetate, potassium octylate, stannous octoate, dibutyl stannic dilaurate, and lead octylate).

In view of foam hardness and resilience, preferred of these are triethylenediamine, stannous octoate, and dibutyl stannic dilaurate.

In view of formability, the amount of the catalyst (F) is preferably 0.01 to 5.0 parts by weight, more preferably 0.05 to 2.0 parts by weight, relative to 100 parts by weight of the polyol composition (C) used in urethane foam production. These catalysts (F) may be used alone or in combination of two or more.

The foam stabilizer (G) can be a known foam stabilizer used in polyurethane foam production (e.g., silicone-based foam stabilizers and non-silicone-based foam stabilizers). Examples include commercially available products such as “SZ-1959”, “SF-2904”, “SZ-1142”, “SZ-1720”, “SZ-1675t”, “SF-2936F”, “SZ-3601”, “SRX-294A”, and “SH-193” from Dow Corning Toray Co., Ltd.; “L-540” and “L-3601” from Nippon Unicar Company Limited; “L-595”, “L-598”, and “L-626” from Momentive Performance Materials; and “B8715 LF2” from Evonik Degussa Japan Co. Ltd.

In view of formability and resilience, the amount of the foam stabilizer (G) is preferably 0.4 to 5.0 parts by weight, more preferably 0.4 to 3.0 parts by weight, relative to 100 parts by weight of the polyol composition (C). These foam stabilizers (G) may be used alone or in combination of two or more.

The flexible polyurethane foam of the present invention may be a foam that was further subjected to urethane-forming reaction using another auxiliary agent described below.

Examples of the other auxiliary agent include known auxiliary components such as colorants (dyes and pigments), plasticizers (e.g., phthalate and adipate), organic fillers (e.g., synthetic short fiber and hollow microspheres made of thermoplastic or thermosetting resin), flame retardants (e.g., phosphate and halogenated phosphate), anti-aging agents (e.g., triazole and benzophenone), and antioxidants (e.g., hindered phenols and hindered amines).

The amounts of these auxiliary agents relative to 100 parts by weight of the polyol composition (C) are as follows. The amount of the colorant is preferably 1 part by weight or less. The amount of the plasticizer is preferably 10 parts by weight or less, more preferably 5 parts by weight or less. The amount of the organic filler is preferably 50 parts by weight or less, more preferably 30 parts by weight or less. The amount of the flame retardant is preferably 30 parts by weight or less, more preferably 2 to 20 parts by weight. The amount of the anti-aging agent is preferably 1 part by weight or less, more preferably 0.01 to 0.5 parts by weight. The amount of the antioxidant is preferably 1 part by weight or less, more preferably 0.01 to 0.5 parts by weight. The total amount of the auxiliary agent is preferably 50 parts by weight or less, more preferably 0.2 to 30 parts by weight.

The flexible polyurethane foam of the present invention can be produced by a known method.

For example, first, specific amounts of the polyol composition (C), the foaming agent (E), the catalyst (F), the foam stabilizer (G), and, if necessary, the other auxiliary agent(s) are mixed together to obtain a mixture.

The mixture is then rapidly mixed with the organic polyisocyanate (D) using a polyurethane foam foaming machine or a stirrer.

The resulting mixture (foam stock solution) is continuously foamed, whereby a flexible polyurethane foam can be obtained.

Alternatively, the foam stock solution is injected into a closed-type or open-type mold (made of metal or resin) for urethane-forming reaction, and after curing for a certain time, the resulting product is released from the mold, whereby a flexible polyurethane foam can be obtained.

The flexible polyurethane foam of the present invention preferably has a resilience at 25° C. of 5 to 12%, more preferably 6 to 10%, in view of elasticity of the polyurethane foam. When the resilience is in the above ranges, the resulting polyurethane foam has good foam hardness and excellent vibration damping properties.

In the present invention, the resilience of the polyurethane foam is a value measured in accordance with JIS K 6400.

The breathability of the flexible polyurethane foam of the present invention is preferably 20 cc/cm²/s or more, more preferably 30 cc/cm²/s or more.

In the present invention, the breathability of the polyurethane foam is a value measured in accordance with JIS K 6400.

The flexible polyurethane foam obtained from the polyol composition (C) for producing flexible polyurethane foam of the present invention is used for furniture, bedding pillows, bedding mattresses, car seat cushions, clothing, and the like.

### EXAMPLES

The present invention is further described below with reference to examples and comparative examples, but the present invention is not limited thereto. Hereinafter, “%” means “wt %” and “part(s)” means part(s) by weight” unless otherwise specified.

### Production Example 1<Production of Polyester Polyol (A1-1)>

In a reaction vessel, PO (1817 parts by weight (27.7 mol)) was added to glycerol (100 parts by weight (1 mol)) using potassium hydroxide (5 parts by weight) as a catalyst at a reaction temperature of 95° C. to 130° C., followed by adsorbent (synthetic magnesium silicate) treatment and filtration to remove potassium hydroxide. Thus, an adduct of PO to glycerol in which the hydroxy value was 95 mg KOH/g was obtained.

Then, phthalic anhydride (965 parts by weight (6 mol)) was added for esterification reaction for one hour. Further, PO (373 parts by weight) was added for addition reaction, whereby a polyester triol (A1-1) was obtained. The hydroxy value was 56 mg KOH/g, and the ester group concentration was 4.0 mmol/g.

### Production Example 2<Production of Polyester Polyol (A1-2)>

Production Example 1 was repeated except that the amount of PO to be added to glycerol (100 parts by weight (1 mol)) was changed to 713 parts by weight (11.3 mol), whereby a polyester triol (A1-2) was obtained. The hydroxy value was 84 mg KOH/g, and the ester group concentration was 6.0 mmol/g.

### Production Example 3<Production of Polyester Polyol (A1-3)>

Production Example 1 was repeated except that the phthalic anhydride (965 parts by weight (6 mol)) was replaced by maleic anhydride (639 parts by weight (6 mol)), whereby a polyester triol (A1-3) was obtained. The hydroxy value was 62 mg KOH/g, and the ester group concentration was 4.4 mmol/g.

### Production Example 4<Production of Polyester Polyol (A1-4)>

Production Example 1 was repeated except that the phthalic anhydride (965 parts by weight (6 mol)) was replaced by trimellitic anhydride (209 parts by weight (1 mol)) and the amount of PO to be added after esterification reaction was changed to 379 parts by weight, whereby a polyester polyol (A1-4) was obtained. The hydroxy value was 108 mg KOH/g, and the ester group concentration was 1.4 mmol/g.

### Production Example 5<Production of Polyether Polyol (B1-1)>

In a reaction vessel, PO (391 parts by weight (6.2 mol)) and EO (1143 parts by weight (23.9 mol)) were added to glycerol (100 parts by weight (1 mol)) for addition reaction using potassium hydroxide (5 parts by weight) as a catalyst at a reaction temperature of 95° C. to 130° C., followed by adsorbent (synthetic magnesium silicate) treatment and filtration to remove potassium hydroxide. Thus, a polyether polyol (B1-1) was obtained. It was a random adduct of PO (6.2 mol) and EO (23.9 mol) to glycerol, in which the hydroxy value was 112 mg KOH/g and the weight percentage of the oxyethylene group unit was 70 wt %.

### Production Example 6<Production of Polyether Polyol (B1-2)>

Production Example 5 was repeated except that the amount of PO was changed to 902 parts by weight (14.3 mol) and the amount of EO was changed to 2660 parts by weight (55.6 mol), whereby a polyether polyol (B1-2) was obtained. It was a random adduct of PO (14.3 mol) and EO (55.6 mol) to glycerol, in which the hydroxy value was 50 mg KOH/g and the weight percentage of the oxyethylene group unit was 73 wt %.

### Production Example 7<Production of Polyether Polyol (B1-3)>

Production Example 5 was repeated except that the glycerol was replaced by propylene glycol, the amount of PO was changed to 298 parts by weight (3.9 mol), and the amount of EO was changed to 926 parts by weight (16.0 mol), whereby a polyether polyol (B1-3) was obtained. It was a random adduct of PO (3.9 mol) and EO (16.0 mol) to propylene glycol, in which the hydroxy value was 111 mg KOH/g and the weight percentage of the oxyethylene group unit was 70 wt %.

### Production Example 8<Production of Polyether Polyol (B2-1)>

Production Example 5 was repeated except that EO was not used and the amount of PO was changed to 713 parts by weight (11.3 mol), whereby a polyether polyol (B2-1) was obtained. It was an adduct of PO (11.3 mol) to glycerol, in which the hydroxy value was 225 mg KOH/g.

### Production Example 9<Production of Polyether Polyol (B2-2)>

Production Example 5 was repeated except that EO was not used and the amount of PO was changed to 3161 part by weight (50.1 mol), whereby a polyether polyol (B2-2) was obtained. It was an adduct of PO (50.1 mol) to glycerol, in which the hydroxy value was 56 mg KOH/g.

### Production Example 10<Production of Polyether Polyol (B2-3)>

Production Example 5 was repeated except that EO was not used and the amount of PO was changed to 5287 parts by weight (83.8 mol), whereby a polyether polyol (B2-3) was obtained. It was an adduct of PO (83.8 mol) to glycerol, in which the hydroxy value was 34 mg KOH/g.

### Production Example 11<Production of Polyether Polyol (B2-4)>

In a reaction vessel, PO (452 parts by weight (5.9 mol)) was added to propylene glycol (100 parts by weight (1 mol)) for addition reaction using potassium hydroxide (5 parts by weight) as a catalyst at a reaction temperature of 95° C. to 130° C., followed by adsorbent (synthetic magnesium silicate) treatment and filtration to remove potassium hydroxide. Thus, a polyether polyol (B2-4) was obtained. It was an adduct of PO (5.9 mol) to propylene glycol, in which the hydroxy value was 270 mg KOH/g.

### Production Example 12<Production of Polyether Polyol (B2-5)>

Production Example 11 was repeated except that the amount of PO was changed to 5269 parts by weight (69.0 mol), whereby a polyether polyol (B2-5) was obtained. It was an adduct of PO (69.0 mol) to propylene glycol, in which the hydroxy value was 27 mg KOH/g.

### Production Example 13<Production of Polymer Polyol (P-1)>

Production Example 5 was repeated except that the amount of PO was changed to 2940 parts by weight and 220 parts by weight of EO was additionally added, whereby a polyether polyol (P′-1) was obtained. The resulting polyether polyol (P′-1) was a random adduct of PO and EO to glycerol, in which the hydroxy value was 56 mg KOH/g and the weight percentage of the oxyethylene group unit was 7 wt %.

In this polyether polyol (P′-1), styrene and acrylonitrile (weight ratio of styrene/acrylonitrile=70/30) were copolymerized, whereby a polymer polyol (P-1) was obtained. Polymer particles of the resulting polymer polyol (polymer content: 44.0 wt %) had a volume average particle size of 0.5 to 0.7 μm.

### <Production of Polyol Composition (C)>

The components described in Tables 1 and 2 were uniformly mixed in a mixing container, whereby polyol compositions of Examples 1 to 15 and Comparative Examples 1 to 5 were produced.

TABLE 1

| | | | | Example | Example | Example | Example | Example | Example | Example | Example | Example | Example |
|---|---|---|---|---|---|---|---|---|---|---|---|---|---|
| Flexible polyurethane foam | | | | 1 | 2 | 3 | 4 | 5 | 6 | 7 | 8 | 9 | 10 |
| Parts | Polyol | Polyester polyol | (A1-1) | 11 | 20 | — | 11 | 24 | — | — | — | — | — |
| (parts by | composition | (A) | (A1-2) | — | — | 11 | — | — | 60 | 16 | — | — | 50 |
| weight) | (C) | | (A1-3) | — | — | — | — | — | — | — | 20 | — | — |
| | | | (A1-4) | — | — | — | — | — | — | — | — | 30 | — |
| | | Polyester polyol | (B1-1) | 24 | 24 | 24 | — | 24 | 23 | 48 | 28 | — | 50 |
| | | (B) | (B1-2) | — | — | — | 30 | — | — | — | — | 24 | — |
| | | | (B1-3) | — | — | — | — | — | — | — | — | — | — |
| | | | (B2-1) | 38 | 38 | 35 | 45 | 28 | 17 | 27 | 38 | 34 | — |
| | | | (B2-2) | 3 | 5 | 6 | — | — | — | [symbol] | — | — | — |
| | | | (B2-3) | 14 | 13 | 14 | 14 | — | — | — | 14 | 12 | — |
| | | | (B2-4) | — | — | — | — | 10 | — | — | — | — | — |
| | | | (B2-5) | — | — | — | — | 14 | — | — | — | — | — |
| | | Polymer polyol (P) | (P-1) | 10 | — | 10 | — | — | — | — | — | — | — |

| Organic poly [symbol] cyanate (D) | | [symbol] | 86 | [symbol] | 86 | [symbol] | 88 | 88 | 88 | 88 | [symbol] |
|---|---|---|---|---|---|---|---|---|---|---|---|
| (isocyanate index) | | | | | | | | | | | |
| Foaming agent (E) | | 1.7 | 1.7 | 1.7 | 1.7 | 1.7 | 1.7 | 1.7 | 1.7 | 1.7 | 1.7 |
| Catalyst (F) | (F-1) | 0.36 | 0.36 | 0.36 | 0.36 | 0.36 | 0.36 | 0.36 | 0.36 | 0.36 | 0.36 |
| | (F-2) | 0.03 | 0.03 | 0.03 | 0.03 | 0.03 | 0.03 | 0.03 | 0.03 | 0.03 | 0.03 |
| | (F-3) | 0.07 | 0.07 | 0.07 | 0.07 | 0.07 | 0.07 | 0.07 | 0.07 | 0.07 | 0.07 |

| | Foam stabilizer (G) | 0.6 | 0.6 | 0.6 | 0.6 | 0.6 | 0.6 | 0.6 | 0.6 | 0.6 | 0.6 |
|---|---|---|---|---|---|---|---|---|---|---|---|
| Ester group concentration | | 0.44 | 0.80 | 0. [symbol] | 0.44 | 0.96 | 3.60 | 0.96 | 0.88 | 0 [symbol] 42 | 3.00 |
| Oxyethylene group unit content (wt %) in (C) | | 17.8 | 17.3 | 17 [symbol] 8 | 21.6 | 16.8 | 16.1 | 33.6 | 19.6 | 17.3 | 36.0 |
| Number average number of functional groups in (C) | | 3.0 | 3.0 | 3.0 | 3.0 | 2.7 | 3.0 | 3.0 | 3.0 | 3.2 | 3.0 |
| Hy [symbol] value (mg KOH/g) of (C) | | 125 | 131 | 132 | 127 | 134 | 114 | 133 | 134 | 12 [symbol] | [symbol] |
| Foam | Resilience (%) | 7 | 6 | 6 | [symbol] | 6 | 6 | 8 | 8 | 7 | 6 |
| physical | Breathability ( [symbol] m²/s) | 121 | 76 | 84 | 110 | 90 | 105 | 114 | 96 | 80 | 77 |
| properties | Restoration time (s) | 2 | 3 | 3 | 2 | 6 | 2 | 2 | 3 | 1 | 2 |

[symbol]

indicates data missing or illegible when filed

TABLE 2

| | | | | Example | Example | Example | Example | Example |
|---|---|---|---|---|---|---|---|---|
| Flexible polyurethane foam | | | | 11 | 12 | 13 | 14 | 15 |
| Parts | Polyol | Polyester | (A1-1) | 3 [symbol] | 3 [symbol] | — | — | 2 [symbol] |
| (parts by | composition | polyol | (A1-2) | — | — | 10 | 8 | — |
| weight) | (C) | (A) | (A1-3) | — | — | — | — | — |
| | | | (A1-4) | — | — | — | — | — |
| | | Polyester | (B1-1) | 3 [symbol] | [symbol] | 2 [symbol] | [symbol] | — |
| | | polyol | (B1-2) | 1 [symbol] | 16 | — | — | — |
| | | (B) | (B1-3) | — | — | — | — | 24 |
| | | | (B2-1) | — | 7 | [symbol] | 40 | 38 |
| | | | (B2-2) | [symbol] | 23 | — | — | [symbol] |
| | | | (B2-3) | — | — | — | — | 13 |
| | | | (B2-4) | — | — | 30 | 30 | — |
| | | | (B2-5) | — | — | — | — | — |
| | Polymer polyol (P) | | (P-1) | — | — | — | — | — |
| | Organic poly [symbol] cyanate (D) | | | 8 [symbol] | [symbol] 3 | 8 [symbol] | [symbol] | [symbol] |
| | (isocyanate index) | | | | | | | |
| | Foaming agent (E) | | | 1.7 | 1.7 | 1.7 | 1.7 | 1.7 |
| | Catalyst (F) | | (F-1) | 0 [symbol] | 0.36 | 0 [symbol] | 0.36 | 0. [symbol] |
| | | | (F-2) | 0.03 | 0.03 | 0.03 | 0.03 | 0. [symbol] |
| | | | (F-3) | 0.07 | 0.07 | 0.07 | 0.07 | 0.07 |
| | Foam stabilizer (G) | | | 0. [symbol] | 0 [symbol] | [symbol] | 0. [symbol] | 0. [symbol] |
| Ester group concentration | | | | [symbol] | [symbol] | 0. [symbol] | [symbol] | [symbol] |
| Oxyethylene group unit content | | | | 2 [symbol] 2 | 33.3 | 17 [symbol] 6 | 1 [symbol] | 1 [symbol] |
| (wt %) in (C) | | | | | | | | |
| Number average number of functional | | | | 3. [symbol] | [symbol] .0 | 3.5 | 2. [symbol] | 2.7 |
| groups in (C) | | | | | | | | |
| Hy [symbol] value (mg KOH/g) of (C) | | | | 7 [symbol] | 81 | 1 [symbol] | [symbol] | 131 |
| Foam | Resilience (%) | | | 13 | 12 | 6 | [symbol] | [symbol] |
| physical | Breathability ( [symbol] m²/s) | | | [symbol] 4 | 80 | 77 | 4 [symbol] | [symbol] |
| properties | Restoration time (s) | | | [symbol] | [symbol] | [symbol] | 7 | 8 |
| | | | | Comparative | Comparative | Comparative | Comparative | Comparative |
| Flexible polyurethane foam | | | | Example 1 | Example 2 | Example 3 | Example 4 | Example 5 |
| Parts | Polyol | Polyester | (A1-1) | 3 | — | 11 | 11 | 11 |
| (parts by | composition | polyol | (A1-2) | — | 70 | — | — | — |
| weight) | (C) | (A) | (A1-3) | — | — | — | — | — |
| | | | (A1-4) | — | — | — | — | — |
| | | Polyester | (B1-1) | [symbol] | 23 | 3 | 1 [symbol] | [symbol] |
| | | polyol | (B1-2) | — | — | — | — | — |
| | | (B) | (B1-3) | — | — | — | — | — |
| | | | (B2-1) | 3 [symbol] | 7 | 44 | 41 | 32 |
| | | | (B2-2) | 11 | — | 1 [symbol] | 9 | — |
| | | | (B2-3) | 14 | — | 1 [symbol] | 14 | — |
| | | | (B2-4) | — | — | — | — | — |
| | | | (B2-5) | — | — | — | — | — |

| Polymer polyol (P) | (P-1) | 10 | — | 10 | 10 | 10 |
|---|---|---|---|---|---|---|
| Organic poly [symbol] cyanate (D) | | [symbol] | [symbol] | [symbol] | [symbol] | [symbol] |
| (isocyanate index) | | | | | | |
| Foaming agent (E) | | 1.7 | 1.7 | 1 [symbol] | 1 [symbol] | 1 [symbol] |
| Catalyst (F) | (F-1) | 0.36 | 0 [symbol] | 0.36 | 0 [symbol] | 0.36 |
| | (F-2) | 0.0 [symbol] | 0.03 | 0.03 | 0.03 | 0.03 |
| | (F-3) | 0.0 [symbol] | 0.07 | 0.07 | 0.07 | 0.07 |

| | Foam stabilizer (G) | 0. [symbol] | 0. [symbol] | 0 [symbol] | 0 [symbol] | 0 [symbol] |
|---|---|---|---|---|---|---|
| Ester group concentration | | [symbol] | 4.20 | [symbol] | [symbol] | [symbol] |
| Oxyethylene group unit content | | 1 [symbol] .8 | 1 [symbol] 6 | 4.1 | 1 [symbol] | 41.5 |
| (wt %) in (C) | | | | | | |
| Number average number of functional | | 3.0 | 3.0 | 3.0 | 3.0 | 3.0 |
| groups in (C) | | | | | | |
| Hy [symbol] value (mg KOH/g) of (C) | | 12 [symbol] | 101 | 12 [symbol] | 128 | 1 [symbol] |
| Foam | Resilience (%) | 18 | Unmeasurable | 8 | 6 | Unmeasurable |
| physical | Breathability ( [symbol] m²/s) | 100 | | 3 | [symbol] | |
| properties | Restoration time (s) | 3 | | 2 | 3 | |

[symbol]

indicates data missing or illegible when filed

The components used in Examples 1 to 15 and Comparative Examples 1 to 5 described in Tables 1 and 2 are as follows.

Polyester polyol (A), polyether polyol (B), and polymer polyol (P): those produced in Production Examples 1 to 13

Organic polyisocyanate (D): a mixture of 2,4-toluene diisocyanate and 2,6-toluene diisocyanate (mixing ratio: 80/20) (TDI) (product name “Coronate T-80” available from Tosoh Corporation (isocyanate group content=48.3 wt %))

Foaming agent (E): water

### <Catalyst (F)>

Catalyst (F-1): triethylenediamine “DABCO-33LX” available from Air Products Japan K.K.
Catalyst (F-2): bisdimethylaminoethyl ether “DABCO-BL22” available from Air Products Japan K.K.
Catalyst (F-3): stannous octoate “NEOSTANN U-28” available from Nitto Kasei Co., Ltd.
Foam stabilizer (G): silicone foam stabilizer “Niax Silicone L-598” available from Momentive Performance

### Materials

### <Production of Flexible Polyurethane Foam>

Mixtures obtained by mixing according to the formulations shown in Tables 1 and 2 were foamed under the following foaming conditions, whereby flexible polyurethane foams were produced.

Numeral values of the raw materials other than the organic polyisocyanate in the formulations of Tables 1 and 2 indicate parts by weight. The organic polyisocyanate was used in an amount corresponding to the isocyanate index shown in the formulations.

### <Foaming Conditions>

Mold size: 250 mm×250 mm×250 mm
Material: wood
Mixing method: hand mixing (a foaming method in which after a required amount of required reagents is added to a predetermined container, a stirring blade is inserted into the container for stirring at a speed of 5000 rotations/minute for 6 to 20 seconds)
Mixing time: 6 to 20 seconds
Stirring blade rotation speed: 5000 rotations/minute

Each resulting flexible polyurethane foam was left to stand at a temperature of 25° C. and a humidity of 50% for 24 hours. Subsequently, the resilience, breathability, and restoration time of each flexible polyurethane foam were measured based on the following measurement methods. Tables 1 and 2 show the results.

### <Test Method for Physical Properties of Flexible Polyurethane Foam>

The measurement method for each item is as follows.

Breathability: It was measured in accordance with JIS K 6400 (unit: cc/cm²/s).
Resilience: It was measured in accordance with JIS K 6400 (unit: %).
Restoration time: A test piece having a size of 50×200×200 (mm) prepared in accordance with JIS K 6500-1 was compressed to the maximum by a test bar having a sharp edge (length: 10 cm; diameter: 25 mm), and subsequently, the load was removed. The time required to restore the original thickness after the removal of the load was measured (unit: sec).

As is clear from Tables 1 and 2, each of the flexible polyurethane foams of Examples 1 to 15 had low resilience at room temperature and good breathability.

In contrast, the polyurethane foam of Comparative Example 1 in which the ester group concentration in the polyol composition (C) was less than 0.4 mmol/g had poor resilience. The polyurethane foam of Comparative Example 2 in which the ester group concentration in the polyol composition (C) was more than 4.0 mmol/g shrunk while being left to stand after foaming, so that the physical properties of the polyurethane foam could not be measured.

The polyurethane foam of Comparative Example 3 and the polyurethane foam of Comparative Example 4 each in which the oxyethylene group unit content in the polyol composition (C) was less than 15 wt % had good resilience at room temperature but had poor breathability (5 cc/cm²/s or less).

The polyurethane foam of Comparative Example 5 in which the oxyethylene group unit content was more than 40 wt % showed an increase in apparent volume by foaming but the foam was crushed immediately. Thus, the flexible polyurethane foam disintegrated, and the physical properties could not be measured.

### INDUSTRIAL APPLICABILITY

The flexible polyurethane foam obtained from the polyol composition (C) for producing flexible polyurethane foam of the present invention has low resilience at room temperature and good breathability, and is thus suitable for seat cushions, bedding (e.g., mattresses and pillows), furniture, and the like.

1. A polyol composition (C) for producing flexible polyurethane foam, comprising:
a polyester polyol (A); and
a polyether polyol (B),
wherein the followings (1) to (4) are satisfied:
(1) the polyol composition (C) has an ester group concentration of 0.4 to 4.0 mmol/g based on the weight of the polyol composition (C);
(2) the polyol composition (C) has an oxyethylene group unit content of 15 to 40 wt % based on the weight of the polyol composition (C);
(3) the polyester polyol (A) includes a polyester polyol (A1) having two to four hydroxy groups in one molecule obtained by polymerization of a raw material containing a compound (a) having multiple hydroxyl groups and a polycarboxylic acid or acid anhydride of the polycarboxylic acid; and
(4) the polyether polyol (B) includes an oxyethylene group-containing polyether polyol (B1).

2. The polyol composition (C) for producing flexible polyurethane foam according to claim 1,
wherein the polyol composition (C) has a hydroxy value of 80 to 200 mg KOH/g.

3. A flexible polyurethane foam,
which is a reaction product of a mixture containing the polyol composition (C) for producing flexible polyurethane foam according to claim 1, an organic polyisocyanate (D), a foaming agent (E), a catalyst (F), and a foam stabilizer (G).

4. The flexible polyurethane foam according to claim 3,
wherein the flexible polyurethane foam has a resilience at 25° C. of 5 to 12%.

5. A flexible polyurethane foam,
which is a reaction product of a mixture containing the polyol composition (C) for producing flexible polyurethane foam according to claim 2, an organic polyisocyanate (D), a foaming agent (E), a catalyst (F), and a foam stabilizer (G).

6. The flexible polyurethane foam according to claim 5,
wherein the flexible polyurethane foam has a resilience at 25° C. of 5 to 12%.
